(19) United States
(12) Patent Application Publication
(10) Pub. No.: US 2015/0356571 A1
(43) Pub. Date: Dec. 10, 2015

(54) Trending Topics Tracking

(71) Applicant: Adobe Systems Incorporated, San Jose, CA (US)

(72) Inventors: Walter W. Chang, San Jose, CA (US); Hartmut Warncke, Hamburg (DE); Emre Demiralp, San Francisco, CA (US)

(21) Appl. No.: 14/297,187

(22) Filed: Jun. 5, 2014

(51) Int. Cl. G06Q 30/02; H04L 12/58; H04L 12/26; G06Q 10/10

(52) U.S. Cl. CPC G06Q 30/0201; G06Q 10/107; H04L 51/046; H04L 43/045

(57) ABSTRACT

In techniques for trending topics tracking, input text data is received as communications from a user or between users, where the communications are from one user to other users, or between two or more of the users. A topics tracking application is implemented to determine topics from the communications that are from or between the users, and track how the topics are trending over a time duration. The topics can include expressed sentiments and/or expressed emotions. An input selection of at least one of the topics can be received, and the topics tracking application generates a visual dashboard that displays a trending representation of the at least one topic that is trending over the time duration. The visual dashboard can also display data sources of the communications between the two or more users and/or an overview of one or more of the topics determined from a selected data source.

### BACKGROUND

Marketing analysts strive to obtain information about topics that customers are discussing and communicating, as well as the opinions or sentiments that may be expressed by the customers in communications about the topics. Companies that provide products and/or services want to know and understand how well a product or service is received, areas where customers are unhappy with the product or service, and to identify product and/or service suggestions or enhancements from customers. Further, it can be important to determine the influence of users, the topics, sentiments, and other variables in social media and other forms of communication.

The marketing analysts, and in some cases even the customers themselves, want to be able to see what the customers are discussing or communicating about, and know what topics are trending up or down. Generally, news sources such as data feeds provide a constant stream of information, but there is not a systematic technique to determine which ones of the topics are important or of interest to a particular individual or other entity. Simple techniques such as tag clouds have been used to analyze text, but these only provide some broad information at best and only for a small snapshot in time. More recently, time-series visual representations of trending topics have been developed, but are only based on ad-hoc analytics and information mining that is limited. Further, the volume of information to analyze is often quite large, such as thousands of communications about any number of various topics. To manually sort and analyze thousands of communications, such as from the customers of a product or service provider, is labor intensive, tedious, and can be error-prone.

### SUMMARY

This Summary introduces features and concepts of trending topics tracking, which is further described below in the Detailed Description and/or shown in the Figures. This Summary should not be considered to describe essential features of the claimed subject matter, nor used to determine or limit the scope of the claimed subject matter.

Trending topics tracking is described. In embodiments, input text data is received as communications from a user or between users, where the communications are from one user to one or more of the users, or between two or more of the users, and the communications can be modeled as a document. A text analytics application generates the input text data based on the communications that are from or between the users, where the text analytics application can include techniques for statistical topic modeling and natural language sentence analysis. A topics tracking application is implemented to determine topics from the communications that are from and/or between the users (e.g., modeled as the document), and track how the topics are trending over a time duration. The topics can include expressed sentiments and/or expressed emotions. In implementations, the time duration is a sliding time window for a trending representation of a topic that is determined from the communications, and the trending representation indicates that the topic is trending up or down over the time duration. The topics tracking application can scan keywords of the document to form the sliding time window for the trending representation of a topic.

The topics tracking application can receive an input selection of one or more of the topics, and generate a visual dashboard that displays the trending representations of the selected topics that are trending over the time duration. The visual dashboard can also display data sources of the communications that are from or between the users and/or an overview of the selected topics as determined from selected data sources. The topics tracking application can receive a user input of a section of a trending representation for a topic, expressed sentiment, or expressed emotion, and the visual dashboard can display a section of the data source that corresponds to the section of the trending representation.

The topics tracking application is also implemented to determine causal relationships between two or more users based in part on the input text data as the communications between the users, and the visual dashboard displays an interaction representation of how interactions between the two or more users influence the topics that are trending over the time duration. In implementations, the topics tracking application computes a smoothed time-series topic trending representation of the topics that are trending over the time duration. The topics tracking application computing the smoothed time-series topic trending representation includes modeling the communications between the two or more users as the document, assigning similarity values to pairs of adjacent blocks of text in the document, and determining a frequency of a keyword phrase localized in one or more of the blocks of text based on the similarity values to identify the topics that are trending over the time duration.

### BRIEF DESCRIPTION OF THE DRAWINGS

Embodiments of trending topics tracking are described with reference to the following Figures. The same numbers may be used throughout to reference like features and components that are shown in the Figures:

FIG. 1 illustrates an example of a device that implements a causal modeling application to implement trending topics tracking in accordance with one or more embodiments.

FIG. 2 illustrates example method(s) of trending topics tracking in accordance with one or more embodiments.

FIG. 3 illustrates an example implementation of the topics tracking application in accordance with one or more embodiments of trending topics tracking.

FIG. 4 illustrates an example term frequency distribution map as an output of the trending topics tracking in accordance with one or more embodiments.

FIG. 5 illustrates an example of statistical term frequency count distributions as an output of the trending topics tracking in accordance with one or more embodiments.

FIGS. 6-9 illustrate example displays of a visual dashboard that is generated in accordance with one or more embodiments of trending topics tracking.

FIG. 10 illustrates an example implementation of a causal modeling application in accordance with one or more embodiments of trending topics tracking.

FIG. 11 illustrates an example of causal modeling between users in accordance with one or more embodiments of trending topics tracking.

FIG. 12 illustrates an example system in which embodiments of trending topics tracking can be implemented.

FIG. 13 illustrates an example system with an example device that can implement embodiments of trending topics tracking.

### DETAILED DESCRIPTION

Embodiments of trending topics tracking are described as techniques to determine trending topics as communications from a user or between users, where the communications are from one user to one or more of the users, or between users, which may be any number of social media users communicating with one another, communications between agents, customer service representatives and customers, and any other group of people who are communicating with one another. A topics tracking application implements techniques to analyze the communications, such as textual documents, social messages, blogs, reviews, and interactive dialogs between communicating users, and the topics tracking application is implemented to determine and show how topics and entities change over time. The topics can include expressed sentiments and/or expressed emotions.

A visual dashboard can then display trending representations of the determined topics that are tending over time. Statistical topic modeling and natural language sentence analysis of information, such as from news feeds, is incorporated in embodiments of trending topics tracking to analyze messages and documents that include topics, which are either trending up or down in importance. The features of trending topics tracking provide that marketers, advertisers, publishers, and consumers can develop personalized visual dashboards of the topics or entities that they are most interested in tracking over time to determine emerging and diminishing topical trends, and then take timely actions to mitigate or exploit the trends.

Embodiments of trending topics tracking can also be used to visualize how the topics, entities, and/or users affect and interact with each other over time, such as by using techniques for dynamical systems modeling. A causal modeling application implements a dynamical causal modeling framework to determine the causal relationships between the topics, sentiments, emotions, and other variables of interest in the communications that are from and/or between users. Generally, a causal relationship can be modeled to account for the relationships between cause and effect, or connections between factors, such as the influences of user communications on other users. The communications can be represented as values, and causal determinations made about the communications. For example, the techniques can be used to identify whether a particular post on a social media site predicts a discussion of certain topics in social media, and vice-versa. Any aspect of textual content that can be quantified, as well as other quantitative indicators, such as stock prices and dates, can be used in this modeling framework. The features of trending topics tracking can also be utilized for various, different applications, such as for content management, metadata, data mining, semantic analysis, multi-user authoring, content monetization, advertising, advertisement insertion, behavior tracking, demographic analytics, social network analytics, and for many other applications.

While features and concepts of trending topics tracking can be implemented in any number of different devices, systems, networks, environments, and/or configurations, embodiments of trending topics tracking are described in the context of the following example devices, systems, and methods.

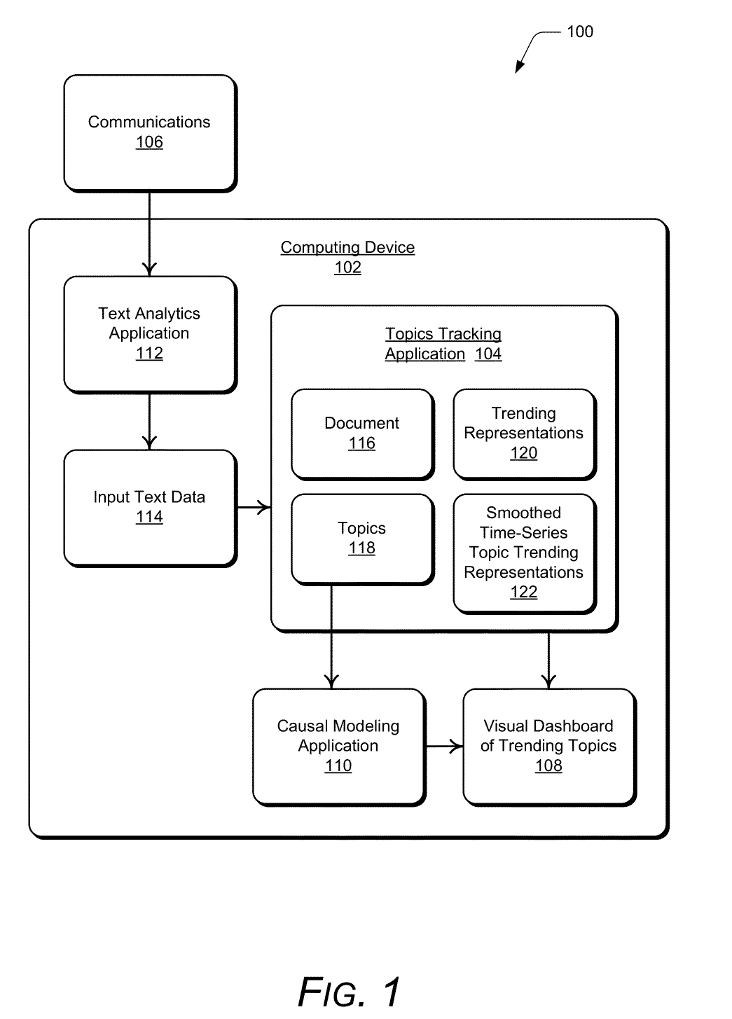

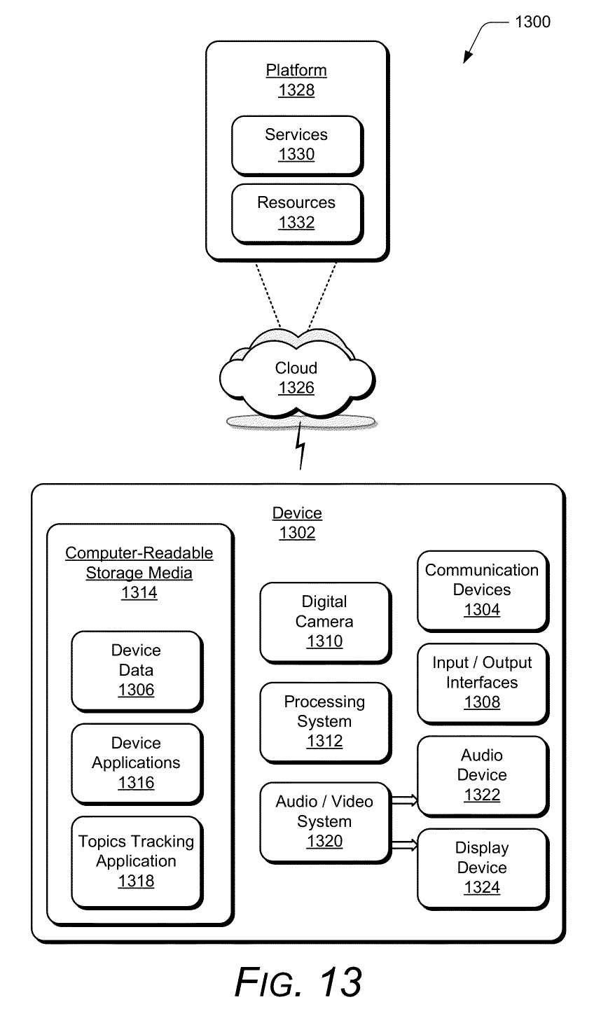

FIG. 1 illustrates an example 100 of a computing device 102 that implements a topics tracking application 104 in embodiments of trending topics tracking. The topics tracking application 104 can be implemented as a software application, such as executable software instructions (e.g., computer-executable instructions) that are executable by a processing system of the computing device 102 and stored on a computer-readable storage memory of the device. The computing device can be implemented with various components, such as a processing system and memory, and with any number and combination of differing components as further described with reference to the example device shown in FIG. 13.

In embodiments, the topics tracking application 104 implements techniques to analyze communications 106, such as textual documents, social messages, blogs, reviews, and interactive dialogs between communicating users, and is implemented to determine and show how topics and entities change over time. The communications 106 are from a user to one or more other users, or between users, which may be any number of social media users communicating with one another, customer service representatives and customers, and any other group of people who are communicating with one another. The topics tracking application 104 generates a visual dashboard 108 of trending topics, and the visual dashboard can also be utilized to visualize how the topics, entities, and/or users affect and interact with each other over time, such as by use of dynamical systems modeling implemented by a causal modeling application 110 (e.g., a software application).

In this example 100, the computing device 102 also includes a text analytics application 112 (e.g., a software application) that is implemented to generate input text data 114 based on the communications that are from and/or between the users, and the text analytics application can include techniques for statistical topic modeling and natural language sentence analysis. Alternatively, the text analytics application 112 may be implemented by another computing device (or server system) at which the input text data 114 is generated and communicated to the computing device 102 as an input to the topics tracking application 104. The input text data 114 can include identified noun expressions, identified verb expressions, and tagged parts-of-speech, as determined by the text analytics application 112 based on the communications 106.

In implementations, the topics tracking application 104 models the input text data 114 as a document 116, and keywords of the document are scanned to form a sliding window from which the topics 118 for any section of the document can be determined. The topics tracking application can then track how the topics are trending over a time duration, as represented by the sliding window, for trending representations 120 of the topics 118 that are determined from the communications. The trending representations 120 of the topics indicate whether the topics are trending up or down over the time duration.

In implementations, the topics tracking application 104 can also compute smoothed time-series topic trending representations 122 of the topics 118 that are trending over the time duration. To compute the smoothed time-series topic trending representations, the topics tracking application can model the communications that are from and/or between users as the document 116 (e.g., determined from the input text data 114), assign similarity values to pairs of adjacent blocks of text in the document, and determine a frequency of keyword phrases that are localized in one or more of the blocks of text based on the similarity values. Computing the smoothed time-series topic trending representations 122 of the topics 118 is further described with reference to FIGS. 6-9 that illustrate examples of the visual dashboard 108.

The topics tracking application can generate the visual dashboard 108 that displays the trending representations 120 of selected topics 118 that are trending over the time duration. The visual dashboard can also display data sources of the communications that are from and/or between the users, and/or display an overview of the selected topics as determined from selected data sources. The topics tracking application can also receive a user input of a displayed section of a trending representation 120 for a topic 118, and the visual dashboard 108 can display a section of the data source that corresponds to the selected section of the trending representation.

In this example 100, the computing device 102 also includes the causal modeling application 110 that is implemented to determine causal relationships between the users based in part on the topics 118 that are determined from the input text data 114. The visual dashboard 108 can also display an interaction representation of how interactions between the users influence the topics 118 that are trending over the time duration. In implementations, the input text data 114 can be generated as vector space representations of the communications that are represented as values for use as the topics 118 by the causal modeling application 110. Although shown and described as separate software applications implemented by the computing device 102, the topics tracking application 104 may include the causal modeling application 110 and/or the text analytics application 112 as integrated components or modules. Alternatively or in addition, the topics tracking application 104 may be implemented to control, or otherwise manage, the causal modeling application 110 and/or the text analytics application 112.

The causal modeling application 110 implements a framework for inferring and quantifying causality using dynamical causal modeling (DCM). The dynamical causal modeling can be utilized to infer cyclical causal relationships, such as the influence of a user A on a user B may be different than the influence of user B on user A. Generally, a causal relationship can be modeled to account for the relationships between cause and effect, or connections between factors, such as the influences of user communications on other users, as described herein. Further, dynamical causal modeling does not assume that random fluctuations are serially uncorrelated, thus allowing for more accurate and simultaneous modeling of influence variables, such as endogenous and exogenous variables.

The endogenous variables are dependent variables or factors in a causal model whose value can be changed or determined based on functional relationships in the model. The endogenous variables can be moderated by feedback from one or more of the users, and a value of an endogenous variable may change, or is determinable, based on the feedback from the users in the modeling framework. The exogenous variables are independent variables or factors in a causal model whose value is independent from the states of other variables in the model, and can have an affect on the model without being affected by it. The exogenous variables independently influence the causal relationships without being affected by feedback from the users in the modeling framework. For example, an endogenous social influencer, such as an on-line blogger, is a user whose behavior is likely to change based on feedback from the other users in a system, whereas an exogenous social influencer could be a topic, such as the date or a holiday, whose influence is not moderated by social media discussions.

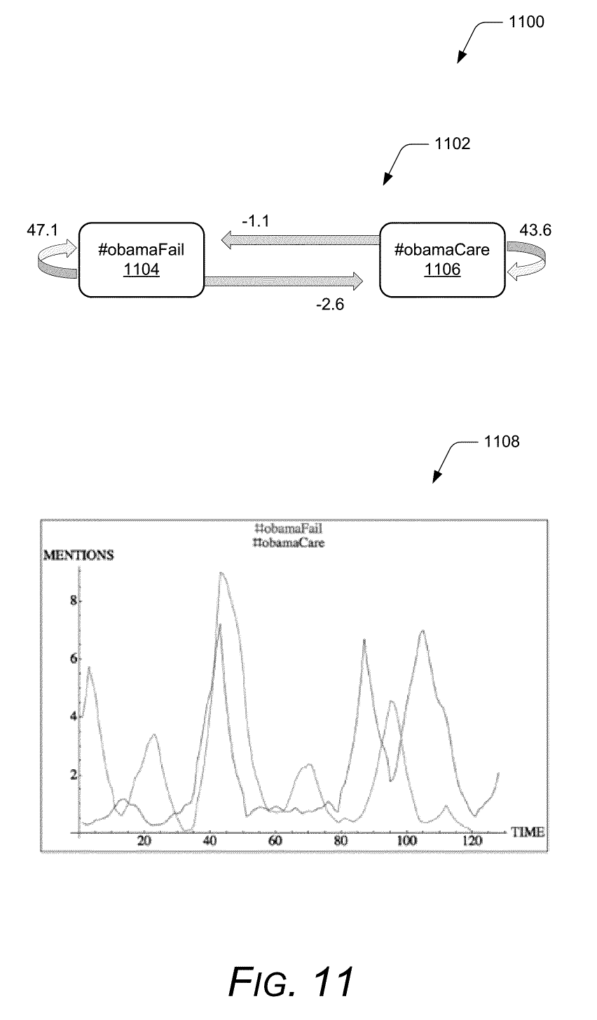

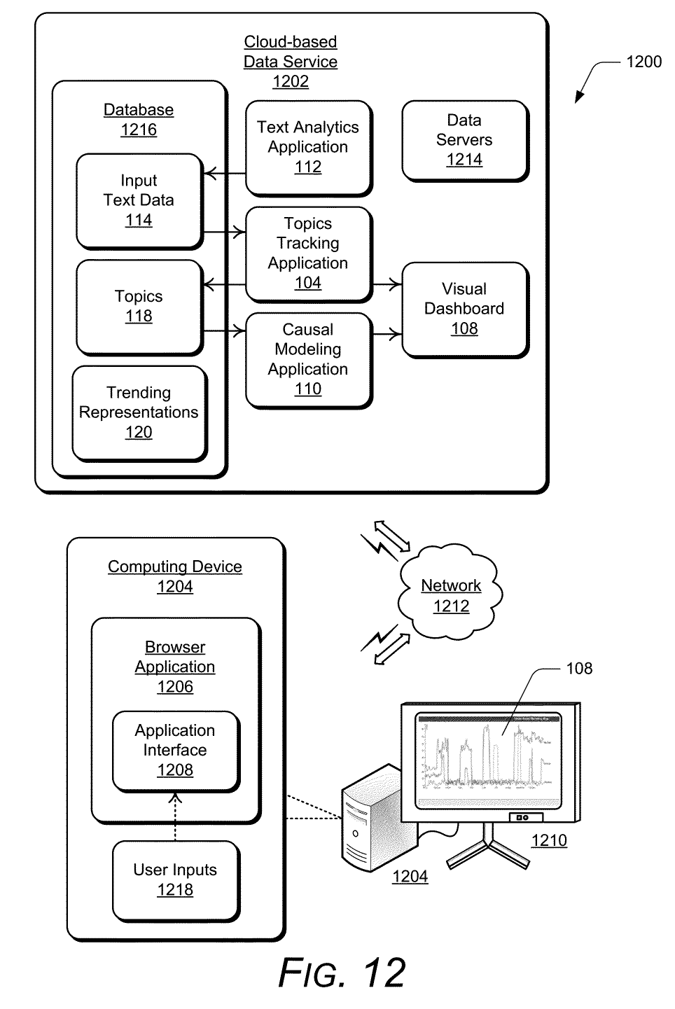

In embodiments, the causal modeling application 110 provides an accurate modeling of causality, influence, and attribution. For instance, when making inferences about the influences of particular social media posts, the causal modeling application is robust to signals that tend to have hysteresis and/or an inertia. Most aspects of on-line communications have their own ebb and flow, and the causal relationships are determined above and beyond that. As noted above, the causal modeling application 104 is implemented for cyclical causal modeling (e.g., user A influences user B, and user B influences user A). For example, a customer service representative (e.g., user A) may be communicating with a concerned client (e.g., user B) on a social media channel, and the causal relationships for user A to user B, and user B to user A, can be separately and accurately determined. The causal modeling application 110 is implemented for processes with hysteresis (e.g., autocorrelation), and can also simultaneously model the endogenous and exogenous variables. Modules and other features of the causal modeling application 110 are further described with reference to FIGS. 10 and 11.

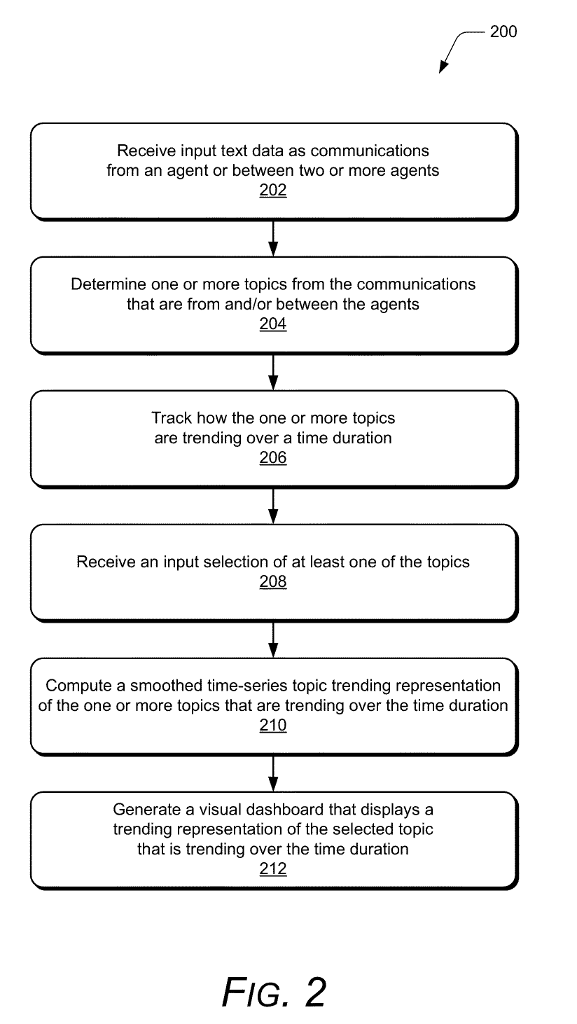

Example method 200 is described with reference to FIG. 2 in accordance with one or more embodiments of trending topics tracking. Generally, any of the services, components, modules, methods, and operations described herein can be implemented using software, firmware, hardware (e.g., fixed logic circuitry), manual processing, or any combination thereof. The example method may be described in the general context of executable instructions stored on a computer-readable storage memory that is local and/or remote to a computer processing system, and implementations can include software applications, programs, functions, and the like.

FIG. 2 illustrates example method(s) 200 of trending topics tracking, and is generally described with reference to a topics tracking application implemented by a computing device. The order in which the method is described is not intended to be construed as a limitation, and any number or combination of the method operations can be combined in any order to implement a method, or an alternate method.

At 202, input text data is received as communications from a user or between users, where the communications are from one user to one or more of the users, or between two or more users. For example, the topics tracking application 104 (FIG. 1) that is implemented by the computing device 102 (or implemented at a cloud-based data service as described with reference to FIG. 12) receives the input text data 114 as the communications 106 from a user or between users, where the communications are from one user to one or more of the users, or between users. In implementations, the input text data 114 can be generated by the text analytics application 112 based on the communications 106 between the users, and the text analytics application includes techniques for statistical topic modeling and natural language sentence analysis.

At 204, one or more topics are determined from the communications that are from and/or between the users. For example, the topics tracking application 104 models the input text data 114 as the document 116, and keywords of the document are scanned to form a sliding window from which the topics 118 for any section of the document are determined, and can be represented as the trending representations 120 of the respective topics. In implementations, such as causal modeling of the communications by the causal modeling application, the topics can include expressed sentiments and/or expressed emotions.

At 206, the one or more topics are tracked to determine how they are trending over a time duration. For example, the topics tracking application 104 tracks the topics 118 to determine how the topics are trending over the time duration, as represented by the sliding window, for the trending representations 120 of the topics 118 that indicate whether the topics are trending up or down over the time duration.

At 208, an input selection of at least one of the topics is received. For example, the topics tracking application 104 receives a user input as a selection of one or more of the topics 118 that may be of interest to the user, such as to determine emerging and diminishing topical trends in the communications 106 that are from and/or between the users.

At 210, a smoothed time-series topic trending representation is computed for the topics that are trending over the time duration. For example, the topics tracking application 104 computes the smoothed time-series topic trending representations 122 by modeling the communications between the users as the document 116 (e.g., determined from the input text data 114), assigning similarity values to pairs of adjacent blocks of text in the document, and then determining a frequency of a keyword phrase localized in one or more of the blocks of text based on the similarity values to identify the topics 118 that are trending over the time duration.

At 212, a visual dashboard is generated that displays a trending representation of the selected topic that is trending over the time duration. For example, the topics tracking application 104 generates the visual dashboard 108 that displays the trending representations 120 of the trending topics 118 that are trending over the time duration. The visual dashboard 108 can also display data sources of the communications 106 that are from and/or between the users, as well as an overview of the topics that are determined from a selected data source. A user input of a displayed section of a trending representation 120 for a topic 118 can be received, and the visual dashboard 108 displays a section of the data source that corresponds to the selected section of the trending representation. The visual dashboard 108 can also be implemented to display an interaction representation of how interactions between the users of the communications influence the topics 118 that are trending over the time duration.

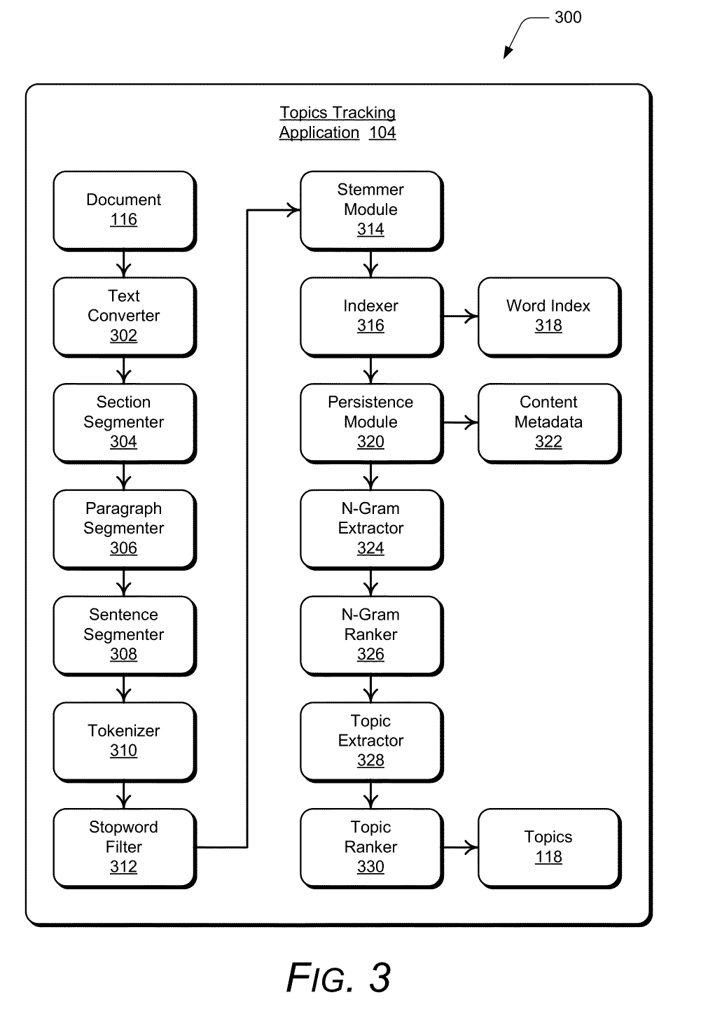

FIG. 3 illustrates an example 300 of the topics tracking application 104 that is implemented by the computing device 102 as described with reference to FIG. 1, and that implements embodiments of trending topics tracking as described herein. Although shown and described as a sequence of independent modules of the topics tracking application, any one or combination of the various modules may be implemented together or independently in the topics tracking application in embodiments of trending topics tracking.

The topics tracking application 104 generates the document 116 from the input text data 114 that is generated by the text analytics application 112 based on the communications 106 that are from and/or between users, as described with reference to FIG. 1. The topics tracking application models the communications as the document 116, and keywords of the document are scanned to form a sliding window from which the topics 118 for any section of the document can be determined. In implementations, the document 116 may be an RSS data feed or email containing multiple topics, and a text converter 302 performs any needed text conversion or formatting of the document. A section segmenter 304 then segments the text into text sections, a paragraph segmenter 306 segments the text sections into paragraphs, and a sentence segmenter 308 segments the paragraphs into sentences. A tokenizer 310 then extracts sentence words from the sentences, and optional stopword filtering of the sentence words is performed by a stopword filter 312 and optional stemming of the sentence words is performed by a stemmer module 314. An indexer 316 then organizes all of the words into an index 318, and optionally, a first persistence module 320 persists the words in the word index 318 as content metadata 322 of the document text.

Once preprocessing of the document text is completed, an N-gram extractor 324 extracts document word n-grams that are processed to create topic model snapshots. An n-gram is a contiguous sequence of n-terms determined from the sequence of the document text, such as with a probabilistic language model used to predict the next text in n-gram sequences of the document text. From the word index 318 output of the indexer 316, and from the content metadata 322 output of the persistence module 320, unigrams, bigrams, trigrams, 4-grams, and 5-grams using optional stopword filtering are extracted by the N-gram extractor 324. The extracted n-grams are then ranked by term frequency (TF) or other criterion by an N-gram ranker 326, and a topic extractor 328 evaluates the set of ranked n-grams to determine the important topics that are then ranked by a topic ranker 330. The extracted and ranked topics are then added to the current topic model as the determined topics 118.

Embodiments of trending topics tracking can be utilized in at least two modes. In a first mode, term frequency inverse document frequency (TFIDF)-based topic models are created for each sliding time window and then presented in a visual manner, such as in the visual dashboard 108, to show the topics 118 that are trending up and down. In a TFIDF-based topic model, the TFIDF reflects the importance of a topic in the document 116, where the TFIDF value increases proportionally to the number of times that a topic appears in the document, and can be offset by the frequency that the topic word appears in the document. In a second mode, a document (conversation-level) topic model can be constructed and may be used to predict the likelihood of topics that occur when topics are encountered.

The topics tracking application 104 can be implemented to compute the TFIDF values of the topics utilizing a standard TF and IDF formulation. This is shown for tfᵢⱼ and for idfᵢ in the equations below:

$${tf}_{i , j} = \frac{{n}_{i , j}}{{\sum }_{k} {n}_{k , j}}$$

$${idf}_{i} = log \frac{\vert D \vert}{\vert \{ {d}_{j} \text{:} {t}_{i} ∈ {d}_{j} \} \vert}$$

$$‖ x ‖ := \sqrt{{x}_{1}^{2} + … + {x}_{n}^{2}}$$

To compute the topic model perplexity, we extend the perplexity equations for language model perplexity and replace words with n-gram themes or topics. This is shown for PP(W) in the equations below:

$$PP ( W ) = \sqrt[N]{{\prod }_{i = 1}^{N} \frac{1}{P ( {W}_{i} \vert {W}_{i - 1} )}}$$

$$P ( {W}_{i} \vert {W}_{i - 1} ) = \frac{c ( {W}_{i - 1} , {W}_{i} )}{c ( {W}_{i - 1} )}$$

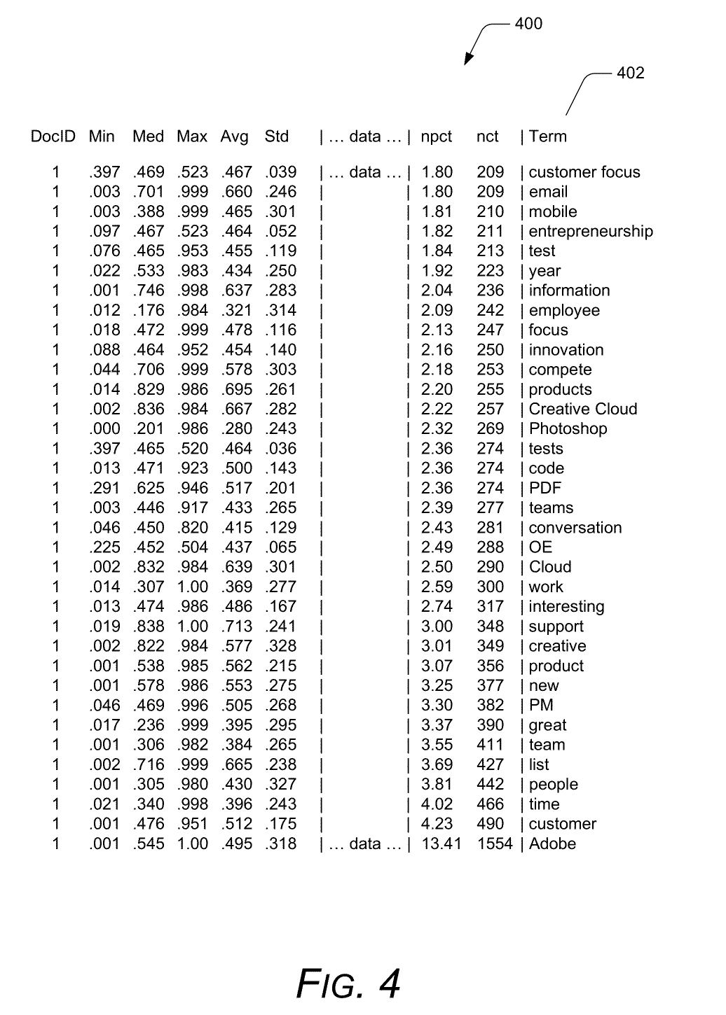

FIG. 4 illustrates an example of a term frequency (TF) distribution map 400 as an output of the topics tracking application 104. The TF distribution map 400 is also referred to as a TF count heatmap that shows the highly frequent terms 402 determined during the topics tracking application analysis, as described with reference to FIG. 3. Additionally, as shown in the TF distribution map, the terms 402 are ranked from the lowest topic occurrence at the top of the distribution map to the highest topic occurrence at the bottom of the distribution map.

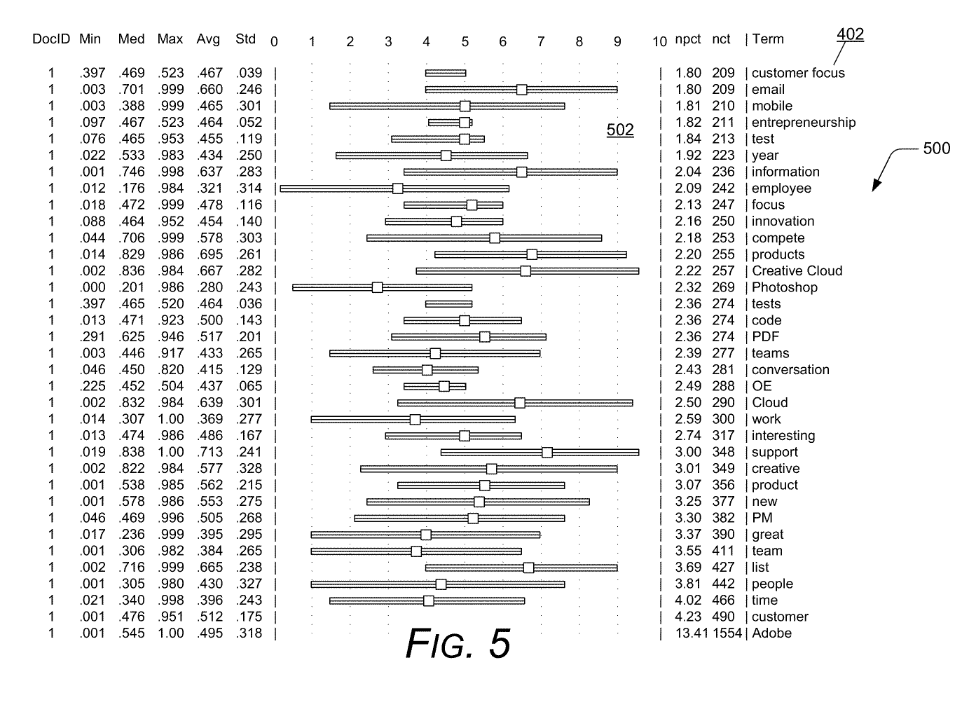

FIG. 5 illustrates an example of statistical term frequency (TF) count distributions 500 of the terms 402 that are the output of the topics tracking application 104 as shown in FIG. 4. The TF count distributions 500 show how the strength of a topic varies over a time duration (e.g., over days, weeks, months, etc.) for the same set of frequently occurring topics 402 that have been determined during the analysis. The solid white squares shown in the TF count distributions indicate the average or mean point in time that a topic occurred over the time window 502.

FIGS. 6-9 illustrate example displays of the visual dashboard 108 that is generated by the topics tracking application 104, as described with reference to FIG. 1. In the examples, the visual dashboard 108 is shown as a graphical user interface that can be displayed on any type of display device, either integrated or connected to a computing device. Further, the examples of the visual dashboard 108 show the trending representations of the topics from selected data sources, and tacking the topics as they are trending over time.

FIG. 6 illustrates an example 600 of the visual dashboard 108 from which a user can initiate utilizing the topics tracking application 104 by selecting and connecting to different data sources 602 (e.g., mail threads, blogs, etc.) to track particular topics over a time duration. The data sources 602 are displayed on the left side of the visual dashboard 108, and can be ordered and/or freely configured by a user. In this example, the user has selected the “Digital Marketing Blog” for viewing and inspection, and the selected blog displays in the Web browser 604 on the right side of the visual dashboard.

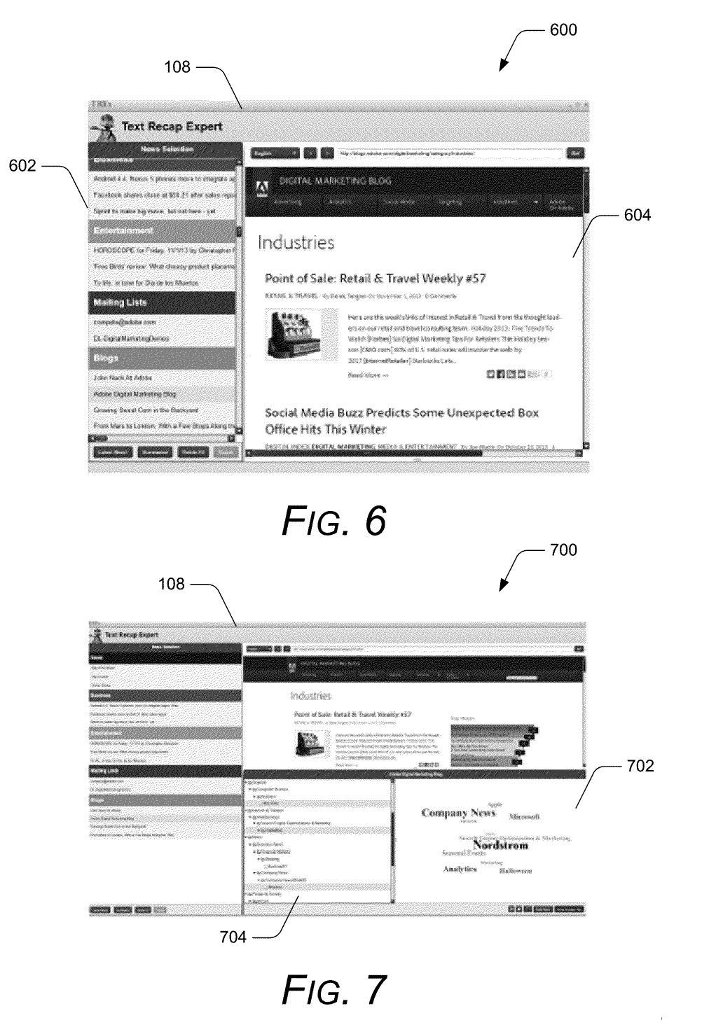

FIG. 7 illustrates an example 700 of the visual dashboard 108 from which the user can select a “Summarize” button to display an overview of the most important topics in the data source (e.g., the “Digital Marketing Blog” from FIG. 6 in this example). Here, a tag cloud 702 of the important topics is displayed on the lower right side in the visual dashboard, and a full category tree 704 is displayed on the left side as a result of text analytics performed by the topics tracking application 104. In this example, the user has selected three topics for tracking from the category tree: “Big Data”, “Amazon”, and “Marketing”. The user can then select the “Track Topics” button (bottom right) to see the trending representations of the topics as they are trending over time.

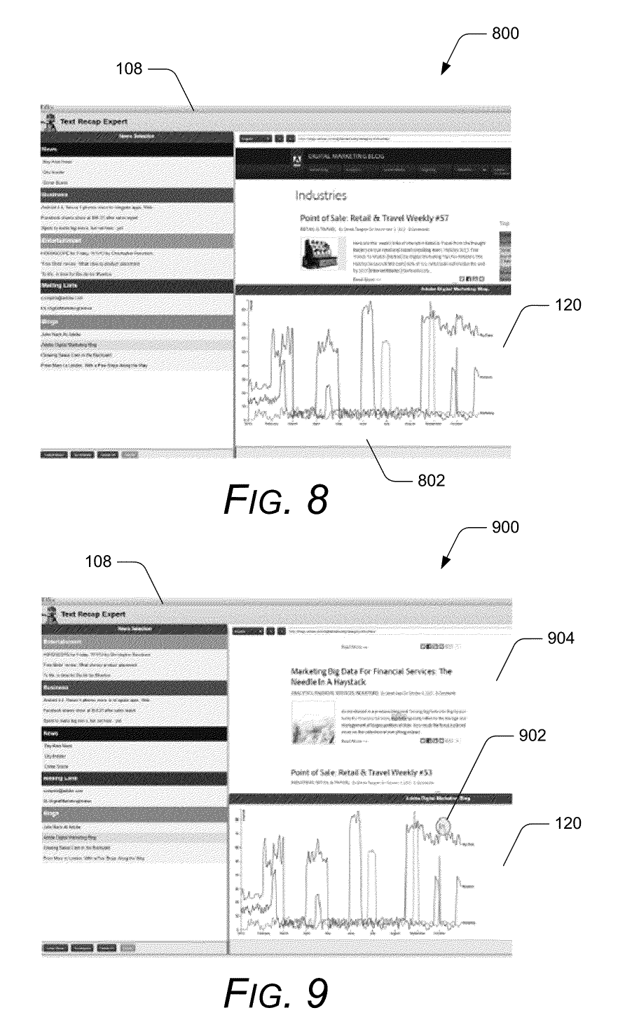

FIG. 8 illustrates an example 800 of the visual dashboard 108, and continuing the example described with reference to FIG. 7, the visual dashboard displays the trending representations 120 for the three user selected topics (e.g., “Big Data”, “Amazon”, and “Marketing”) that are trended over the time duration 802.

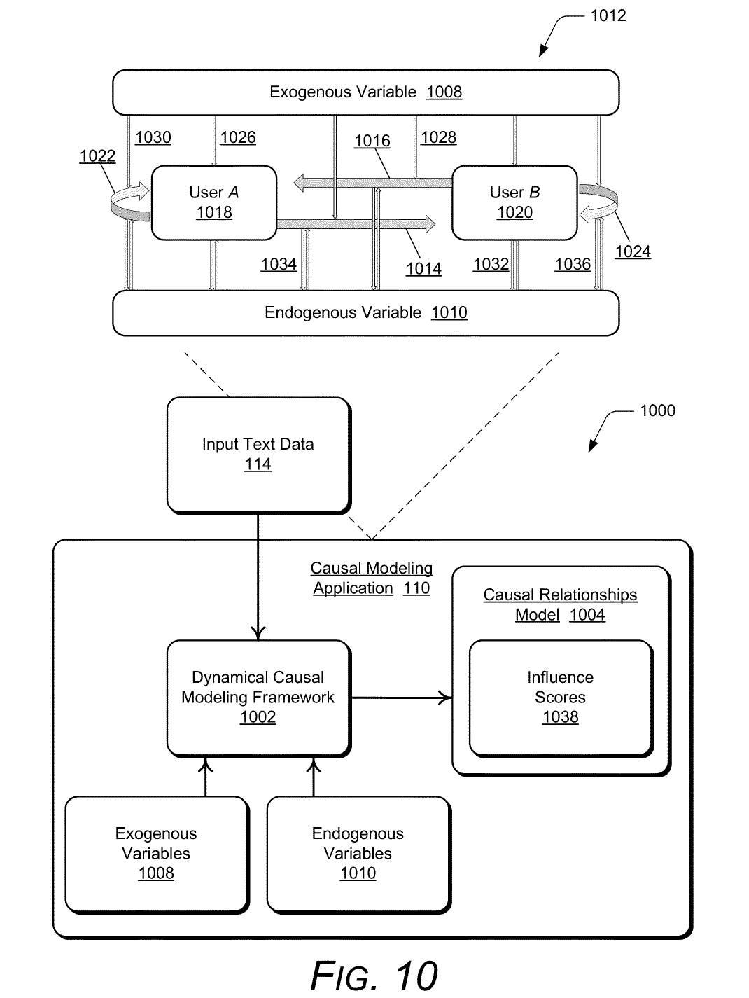

FIG. 9 illustrates an example 900 of the visual dashboard 108, and displays that a user can set a highlighted area 902 of a trending representation (e.g., for the “Big Data” topic beginning in October in the timeline). This user selection can automatically navigate the user to a blog entry 904 shown displayed in the upper right of the visual dashboard. This provides that the user can track the trending topics over time and also quickly navigate through the data sources to search for relevant topics and entities.

As described with reference to FIG. 1, the topics tracking application 104 can be implemented to compute smoothed time-series topic trending representations 122 of the topics 118 that are trending over the time duration. In implementations, the topics tracking application 104 can utilize TextTiling to smooth the trending representations of the topics. Embodiments of trending topics tracking can incorporate techniques of temporal topic segmentation with smoothing for topic detection, segmentation, and change that reflects the actual trending and fading of key underlying subtopics which often spans users and message boundaries.

To compute a smoothed time-series topic trending visualization, the topics tracking application 104 can implement a modified method of the TextTiling algorithm first proposed by M. Hearst et. al. by treating an entire social conversation transaction or session as a temporal discourse document analyzed by sliding a fuzzy boundary topic window across the discourse text to generate fuzzy segmentation of topics to give a trending topic, sentiment, or causality timeline. In the modified TextTiling approach, the multi-message/multi-user social discourse (e.g., represented as the full-length text document 116) is partitioned into coherent multi-paragraph units that represents topic clusters occurring in the time stream of the discourse. The TextTiling approach in Hearst approximates the subtopic structure of a document by using patterns of lexical connectivity to find coherent sub-discussions. The modified TextTiling approach approximates trending and fading subtopic structure and topic sentiment by first discovering the N-gram distributions and then using temporal patterns of both lexical and semantic connectivity across keyword phrases or N-grams to find coherent discussion clusters around thread topics over time.

In the original TextTiling, the layout of tiles is meant to reflect the pattern of subtopics contained in an expository text. In the modified temporal model, the sequential emergence and decay of topic clusters directly reveals trending and fading discussion topics. Similar to Hearst, the modified TextTiling approach implemented by the topics tracking application uses quantitative lexical analysis to determine the extent of the tiles or clusters to classify them with respect to a general topic ontology.

The algorithm of the modified TextTiling approach is a two-step process. First, all pairs of adjacent message blocks of text, where the message blocks are keyword phrases that form noun, verb, or adjective expressions with or without sentiment (unlike Hearst which uses larger sentence units), phrases are compared and assigned a similarity value, and then the resulting sequence of similarity values, after being graphed and optionally smoothed, are examined for peaks and valleys. High similarity values tend to form as peaks and imply that the adjacent blocks cohere well, whereas low similarity values create valleys and indicate a potential boundary between tiles.

In the modified TextTiling approach to implement an algorithm for topic cluster similarity for the topic smoothing aspect, a key adjustable parameter is the number of messages or size of the block used for comparison during the smoothing. This value, labeled k, can vary slightly from text to text, and as a heuristic, is assigned the average discussion paragraph length in keyword phrases within a sentence versus sentence level. Although the block size that best matches what would be human judgment data is sometimes one sentence greater or fewer, for finer granularity topic or sentiment trending visualization, keyword phrases or N-gram sequences are utilized in implementations of the topics tracking application. Actual paragraphs are not generally used due to their lengths being potentially large, leading to unbalanced comparisons.

In implementations, similarity can be measured by a variation of the TFIDF measurement. In standard TFIDF, terms that are frequent in an individual document, but relatively infrequent throughout the corpus, are considered to be good distinguishers of the contents of the individual document. In the modified TextTiling approach, each block of k keyword phrases (or individual social media messages) are treated as a unit by itself, and the frequency of a term within each block is compared to its frequency in the entire document or discourse. This identifies a distinction between local and global extent of terms within the social discourse, such as within the scope of a few exchanged messages or comments, or in the broader context of the entire collection of messages. If a term is discussed frequently, but within a localized cluster thus indicating a cohesive passage, then it will be weighted more heavily than if it appears frequently, but scattered evenly throughout the entire document or discourse, or infrequently within one block. Thus if adjacent blocks share many terms, and those shared terms are weighted heavily, there is strong evidence that the adjacent blocks cohere with one another.

Similarity between blocks is calculated by a cosine measure, and given two text blocks b₁ and b₂:

$$sim ( {b}_{1} , {b}_{2} ) = \frac{{\sum }_{t} {𝓌}_{t , {b}_{1}} {𝓌}_{t , {b}_{2}}}{\sqrt{{\sum }_{t} {𝓌}_{t , {b}_{1}}^{2} {𝓌}_{t , {b}_{2}}^{2}}}$$

where t ranges over all of the terms in the document and ω_{t,b}_{₁} is the TFIDF weight assigned to term t in block b₁. Thus if the similarity score between two blocks is high, then not only do the blocks have terms in common, but the terms they have in common are relatively rare with respect to the rest of the document. The evidence in the reverse is not as conclusive. For example, if adjacent blocks have a low similarity measure, this does not necessarily mean they don't cohere. However, in practice this negative evidence is often justified.

The graph is then smoothed using Hearst's discrete convolution of the similarity function with the function hₖ(i), where:

$${h}_{k} ( i ) ≡ \{ \begin{matrix}\frac{1}{{k}^{2}} ( k - \vert i \vert ) , & \vert i \vert \leq k - 1 \\ 0 , & otherwise\end{matrix}$$

and the result can be further smoothed using a median smoothing algorithm, with a window of size three, to eliminate small local minima. Tile boundaries are determined by locating the lowermost portions of valleys in the resulting plot. The actual values of the similarity measures are not taken into account, but rather the relative differences are what are of consequence.

FIG. 10 illustrates an example 1000 of the causal modeling application 110 that is implemented by the computing device 102 as described with reference to FIG. 1, and that implements embodiments of trending topics tracking. The causal modeling application 110 includes various modules and implements a dynamic causal modeling framework 1002 that generates a causal relationships model 1004 of the input text data 114. Although shown and described as independent modules of the causal modeling application, any one or combination of the various modules may be implemented together or independently in the causal modeling application in embodiments of trending topics tracking.

The dynamical causal modeling framework 1002 of the causal modeling application 110 is implemented to receive the input text data 114 as a representation of the communications 106 that are from and/or between users, and can also receive input as exogenous variables 1008 and/or endogenous variables 1010. The exogenous and/or endogenous variables are referred to herein as influence variables that influence the causal relationships between the users. An example system 1012 illustrates communications 1014, 1016 between users, such as a user A 1018 and a user B 1020. In this example, communications 1014 from user A are communicated to user B, and communications 1016 from user B are communicated to user A. The dynamical causal modeling framework also accounts for hysteresis corrections associated with one or more of the users. For example, user A 1018 in the example system 1012 has an associated hysteresis correction 1022, and user B 1020 has an associated hysteresis correction 1024.

The exogenous variables 1008 independently influence the causal relationships without being affected by feedback from the users. In the example system 1012, the exogenous variable 1008 is shown to influence the users at 1026, influence the communications at 1028, and influence the hysteresis corrections at 1030, all without feedback from the system. The endogenous variables 1010 are moderated by feedback from one or more of the users, and the causal relationships between the users can be determined based on the endogenous variables that influence the causal relationships. In the example system 1012, the endogenous variable 1010 is shown to influence the users at 1032, influence the communications at 1034, and influence the hysteresis corrections at 1036, all with feedback from the system.

The dynamic causal modeling framework 1002 can determine the causal relationships between the users based on the input text data 114 and simultaneous modeling of the exogenous variables 1008 and the endogenous variables 1010. The dynamic causal modeling framework 1002 can generate the causal relationships model 1006 based on the influence variables and the causal relationships between the users, and the causal relationships model is representative of causality, influence, and attribution between the users. The causal relationships can also be quantified with influence scores 1038 that each indicate a degree to which one of the users influences a causal relationship with another of the users. The dynamic causal modeling is implemented to model cyclic relationships such as to simultaneously model the degree to which mentions of a first topic predict mentions of a second topic, and vice-versa. The dynamic causal modeling does not assume that random fluctuations are serially uncorrelated, which is important when modeling causality in topics, because often it is the case that the degree to which a particular topic is mentioned in any given day is, to a large degree, predicted by the degree to which it was mentioned in the day or week before.

The dynamic causal modeling framework 1002 uses a simple deterministic model to characterize the relationships between a set of concepts, entities, or words (or any other feature that can be extracted from the text, or any other input data that is externally available, such as economic indicators). The dynamic causal modeling framework models the change of a state-vector x in time, where each concept or feature is represented by a single state (this state could be a hidden state), using the following bilinear equation:

$$\dot{x} = f ( x , u , θ ) = Ax + {\sum }_{j = 1}^{m} {u}_{j} {B}^{( j )} x + Cu$$

$$A = \frac{\partial f}{\partial x} {\vert}_{u = 0} B = \frac{{\partial }^{2} f}{\partial x \partial u} \vert C = \frac{\partial f}{\partial u} {\vert}_{x = 0}$$

where x′=dx/dt. This equation can be obtained from the bilinear Taylor approximation of any model, where changes in linguistic features in one node xᵢ are caused by the other nodes. This bilinear form is the simplest low-order approximation that has both the endogenous (internal, interdependent) and exogenous (external, independent) causes of the dynamics. The exogenous input is represented by u(t) and the matrix A in Ax represents the dynamic coupling and interaction that is present in the absence of external influencers. For instance, when investigating the influence of holidays on discourse about online purchases, u(t) would represent external influencers such as a day of the week, holidays, and other factors that can't be influenced by the users whose dynamics are being investigated. Matrix A represents how the users, which in the case of linguistic features, topics being discussed influence each other. For instance, does talking about “services in the cloud” make people more likely to talk about “the company”? The B matrix effectively represents the way in which exogenous effects moderate the endogenous interactions that are present in the system. For instance, does the relationship described above between “services in the cloud” and “the company” change as a function of the time of the day or day of the week.

The dynamic causal modeling framework described above can be generalized to encode richer causal interactions between endogenous and exogenous users. For instance, one could begin to ask questions about how presence of certain topics influence or moderate dynamics within the system. In the equation below, this is represented in the form of matrix D, which is the extension of the Taylor series to the second order in states.

$$f ( x , u ) = ( A + {\sum }_{i = 1}^{m} {u}_{i} {B}^{( i )} + {\sum }_{j = 1}^{m} {x}_{j} {D}^{( i )} ) x + Cu$$

The parameters of the dynamic causal modeling framework 1002 are estimated using a Bayesian framework, which allows for empirical or theoretical priors to be enforced on the estimation procedure. Furthermore, the platform allows for regularization approaches as well as zero-mean shrinkage priors which produces more robust results. In a particular instance, the Gaussian observation error is modeled as a linear combination of covariance components and the posterior moments of the parameters are updated iteratively using variational Bayes with a fixed Laplace approximation. Gradient ascent can be used during these updates, and note the significance of the informed priors as they condition the objective function by suppressing local minima that are too far from the prior mean. The iterative approach can be coupled with a regularization scheme.

As described above, vector space representations of textual content can be generated by the text analytics application 112. However, the described techniques can be implemented with any vector space representation of textual content, making the approach applicable to multiple domains and businesses. In implementations, longitudinal bodies of text (e.g., chat, text stream, etc.) are converted to vector space representations using a text analytics engine. This format converts the longitudinal textual communications into multiple time series, where each time series represents the degree to which a particular topic, sentiment, or any other linguistic feature is present in the text. These time series constitute the values for the nodes xᵢ described above, and the parameters of the model are estimated as described above. Once these parameters are obtained, the role of the endogenous and exogenous variables on the dynamics of the system can be inferred as described previously.

FIG. 11 illustrates an example 1100 of causal modeling implemented by the causal modeling application 110, as described with reference to FIG. 10. In this example, the mentions of certain hashtags on Twitter were counted over time, and focus on a debate taking place about the proposed Obama Care plan. The causal modeling application applies dynamical causal modeling 1102 to the data, which indicates the degree to which hashtags for #obamaFail 1104 and #obamaCare 1106 were present in discussions in social media (e.g., the relevant hashtags with highest volume), and fluctuations in mentions of #obamaFail and #obamaCare are shown in the plot 1108.

With the causal modeling application 110, the parameters of the model are estimated, and as shown in the example, the causal influence of #obamaFail on #obamaCare (−2.6) and the causal influence of #obamaCare on #obamaFail (−1.1) are estimated simultaneously. These parameters are also estimated together with the hysteresis or inertia of the topics represented by the loops exiting and entering #obamaFail (47.1) and #obamaCare (43.6). Phenomenologically, the causal influence of #obamaFail on #obamaCare can be the degree to which mentions of #obamaFail at a particular time are associated with the mentions of #obamaCare at subsequent time points. Similarly, the cyclical arrow leaving #obamaFail and entering #obamaFail indicate the degree to which mentions of #obamaFail at a particular time are associated with mentions of #obamaFail at subsequent time points.

The modeling shows a non-symmetric causal relationship between #obamaCare 1106 and #obamaFail 1104. Specifically, #obamaFail at a particular time point is more than twice as strongly negatively associated (−2.6) with mentions of #obamaCare in future time points compared to the reverse causal relationship (−1.1). In other words, the negative sequel of an #obamaFail mention on mentions of #obamaCare is more potent than the prospective decrease in the mentions of #obamaFail following the mention of #obamaCare. Also note that the parameters representing hysteresis or inertia (47.1 and 43.6) are quite strong as is the case with most social media phenomena, where the degree to which a particular related hashtag is mentioned is highly related to the degree to which it was mentioned in the previous time point, which is a property of most human communication.

FIG. 12 illustrates an example system 1200 in which embodiments of trending topics tracking can be implemented. The example system 1200 includes a cloud-based data service 1202 that a user can access via a computing device 1204, such as any type of computer, mobile phone, tablet device, and/or other type of computing device. The computing device 1204 can be implemented with a browser application 1206 through which a user can access the data service 1202 and initiate a display of an application interface 1208, such as the visual dashboard 108, which may be displayed on a display device 1210 that is connected to the computing device. The computing device 1204 can be implemented with various components, such as a processing system and memory, and with any number and combination of differing components as further described with reference to the example device shown in FIG. 13.

In embodiments of trending topics tracking, the cloud-based data service 1202 is an example of a network service that provides an on-line, Web-based version of the topics tracking application 104 that a user can log into from the computing device 1204 and display the application interface 1208. The network service may be utilized by any client, such as marketers and product and/or service providers, to generate analysis outputs and reports to determine topics that customers are discussing or communicating, as well as the related sentiments, emotions, and opinions that are being expressed by customers in their communications. The data service can also maintain and/or upload the input text data 114 that is generated by the text analytics application 112 and input to the topics tracking application 104.

Any of the devices, data servers, and networked services described herein can communicate via a network 1212, which can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

The cloud-based data service 1202 includes data servers 1214 that may be implemented as any suitable memory, memory device, or electronic data storage for network-based data storage, and the data servers communicate data to computing devices via the network 1212. The data servers 1214 maintain a database 1216 of the input text data 114 and the determined topics 118 (e.g., as a topic model), as well as the trending representations 120 of the topics 118 that are generated by the topics tracking application 104. The cloud-based data service 1202 can also include the causal modeling application 110 that can apply dynamical causal modeling of the topics as described herein.

The cloud-based data service 1202 includes the topics tracking application 104, the causal modeling application 110, and the text analytics application 112, such as software applications (e.g., executable instructions) that are executable with a processing system to implement embodiments of trending topics tracking. The applications can be stored on a computer-readable storage memory, such as any suitable memory, storage device, or electronic data storage implemented by the data servers 1214. Further, the data service 1202 can include any server devices and applications, and can be implemented with various components, such as a processing system and memory, as well as with any number and combination of differing components as further described with reference to the example device shown in FIG. 13.

The data service 1202 communicates the trending representations 120 of the topics 118 and the visual dashboard 108 of the topics tracking application 104 to the computing device 1204 where the visual dashboard is displayed, such as through the browser application 1206 and displayed on the display device 1210 of the computing device. The topics tracking application 104 can also receive user inputs 1218 to the application interface 1208, such as when a user at the computing device 1204 initiates a user input with a computer input device or as a touch input on a touchscreen of the device. The computing device 1204 communicates the user inputs 1220 to the data service 1202 via the network 1212, where the topics tracking application 104 receives the user inputs.

FIG. 13 illustrates an example system 1300 that includes an example device 1302, which can implement embodiments of trending topics tracking. The example device 1302 can be implemented as any of the devices and/or server devices described with reference to the previous FIGS. 1-12, such as any type of client device, mobile phone, tablet, computing, communication, entertainment, gaming, media playback, digital camera, and/or other type of device. For example, the computing device 102 shown in FIG. 1, as well as the computing device 1204 and the data service 1202 (and any devices and data servers of the data service) shown in FIG. 12 may be implemented as the example device 1302.

The device 1302 includes communication devices 1304 that enable wired and/or wireless communication of device data 1306, such as the topics trending data and other associated data. The device data can include any type of audio, video, and/or image data, as well as the images and denoised images. The communication devices 1304 can also include transceivers for cellular phone communication and/or for network data communication.

The device 1302 also includes input/output (I/O) interfaces 1308, such as data network interfaces that provide connection and/or communication links between the device, data networks, and other devices. The I/O interfaces can be used to couple the device to any type of components, peripherals, and/or accessory devices, such as a digital camera device 1310 and/or display device that may be integrated with the device 1302. The I/O interfaces also include data input ports via which any type of data, media content, and/or inputs can be received, such as user inputs to the device, as well as any type of audio, video, and/or image data received from any content and/or data source.

The device 1302 includes a processing system 1312 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 1302 may further include any type of a system bus or other data and command transfer system that couples the various components within the device. A system bus can include any one or combination of different bus structures and architectures, as well as control and data lines.

The device 1302 also includes computer-readable storage media 1314, such as storage memory and data storage devices that can be accessed by a computing device, and that provide persistent storage of data and executable instructions (e.g., software applications, programs, functions, and the like). Examples of computer-readable storage media include volatile memory and non-volatile memory, fixed and removable media devices, and any suitable memory device or electronic data storage that maintains data for computing device access. The computer-readable storage media can include various implementations of random access memory (RAM), read-only memory (ROM), flash memory, and other types of storage media in various memory device configurations.

The computer-readable storage media 1314 provides storage of the device data 1306 and various device applications 1316, such as an operating system that is maintained as a software application with the computer-readable storage media and executed by the processing system 1312. In this example, the device applications also include a topics tracking application 1318 that implements embodiments of trending topics tracking, such as when the example device 1302 is implemented as the computing device 102 shown in FIG. 1 or the data service 1202 shown in FIG. 12. An example of the topics tracking application 1318 includes the topics tracking application 104 implemented by the computing device 102 and/or at the data service 1202, as described in the previous FIGS. 1-12.

The device 1302 also includes an audio and/or video system 1320 that generates audio data for an audio device 1322 and/or generates display data for a display device 1324. The audio device and/or the display device include any devices that process, display, and/or otherwise render audio, video, display, and/or image data, such as the image content of a digital photo. In implementations, the audio device and/or the display device are integrated components of the example device 1302. Alternatively, the audio device and/or the display device are external, peripheral components to the example device.

In embodiments, at least part of the techniques described for trending topics tracking may be implemented in a distributed system, such as over a “cloud” 1326 in a platform 1328. The cloud 1326 includes and/or is representative of the platform 1328 for services 1330 and/or resources 1332. For example, the services 1330 may include the data service 1202 as described with reference to FIG. 12. Additionally, the resources 1332 may include the topics tracking application 104, the causal modeling application 110, and/or the text analytics application 112 that are implemented at the data service as described with reference to FIG. 12.

The platform 1328 abstracts underlying functionality of hardware, such as server devices (e.g., included in the services 1330) and/or software resources (e.g., included as the resources 1332), and connects the example device 1302 with other devices, servers, etc. The resources 1332 may also include applications and/or data that can be utilized while computer processing is executed on servers that are remote from the example device 1302. Additionally, the services 1330 and/or the resources 1332 may facilitate subscriber network services, such as over the Internet, a cellular network, or Wi-Fi network. The platform 1328 may also serve to abstract and scale resources to service a demand for the resources 1332 that are implemented via the platform, such as in an interconnected device embodiment with functionality distributed throughout the system 1300. For example, the functionality may be implemented in part at the example device 1302 as well as via the platform 1328 that abstracts the functionality of the cloud 1326.

Although embodiments of trending topics tracking have been described in language specific to features and/or methods, the appended claims are not necessarily limited to the specific features or methods described. Rather, the specific features and methods are disclosed as example implementations of trending topics tracking.

1. A method, comprising:
receiving input text data as communications from a user or between users, the communications being from the user to one or more of the users, or between two or more of the users;
determining one or more topics from the communications that are from or between the users;
tracking how the one or more topics are trending over a time duration;
receiving an input selection of at least one of the topics; and
generating a visual dashboard that displays a trending representation of the at least one topic that is trending over the time duration.

2. The method as recited in claim 1, wherein the time duration is a sliding time window for the trending representation of the at least one topic, and the trending representation indicates that the topic is trending up or down over the time duration.

3. The method as recited in claim 2, further comprising:
modeling the communications that are from or between the users as a document; and
scanning keywords of the document to form the sliding time window for the trending representation of the at least one topic.

4. The method as recited in claim 1, further comprising:
generating the input text data based on a text analytics application applied to the communications that are from or between the users, the text analytics application including statistical topic modeling and natural language sentence analysis; and
wherein the one or more topics include at least one of expressed sentiments and expressed emotions.

5. The method as recited in claim 1, further comprising:
determining causal relationships between the two or more users based in part on the input text data from the communications; and
wherein the visual dashboard displays an interaction representation of how interactions between the two or more users influence the at least one topic that is said trending over the time duration, the at least one topic including an expressed sentiment or an expressed emotion.

6. The method as recited in claim 1, further comprising:
computing a smoothed time-series topic trending representation of the at least one topic that is trending over the time duration, the computing including:
modeling the communications that are from or between the users as a document;
assigning similarity values to pairs of adjacent blocks of text in the document; and
determining a frequency of a keyword phrase localized in one or more of the blocks of text based on the similarity values to identify the at least one topic that is trending over the time duration.

7. The method as recited in claim 1, wherein the visual dashboard displays any one or combination of:
one or more data sources of the communications that are from or between the users;
an overview of one or more of the topics determined from a selected data source; and
the trending representation of the at least one topic that is trending over the time duration.

8. The method as recited in claim 7, further comprising:
receiving a user input of a section of the trending representation, and wherein the visual dashboard displays a section of the data source that corresponds to the section of the trending representation.

9. A computing device, comprising:
a memory configured to maintain input text data that is received as communications from a user or between users;
a processor system to implement a topics tracking application that is configured to:
determine one or more topics from the communications that are from or between the users, the one or more topics including at least one of expressed sentiments and expressed emotions;
track how the one or more topics are trending over a time duration; and
generate a visual dashboard that displays a trending representation of at least one of the topics that is trending over the time duration.

10. The computing device as recited in claim 9, wherein the time duration is a sliding time window for the trending representation of the at least one topic, and the trending representation indicates that the topic is trending up or down over the time duration.

11. The computing device as recited in claim 10, wherein the topics tracking application is configured to:
model the communications that are from or between the users as a document; and
scan keywords of the document to form the sliding time window for the trending representation of the at least one topic.

12. The computing device as recited in claim 9, wherein the topics tracking application is configured to generate the input text data based on a text analytics application applied to the communications that are from or between the users, the text analytics application including statistical topic modeling and natural language sentence analysis.

13. The computing device as recited in claim 9, wherein the topics tracking application is configured to:
determine causal relationships between the two or more users based in part on the input text data from the communications; and
wherein the visual dashboard displays an interaction representation of how interactions between the two or more users influence the at least one topic that is said trending over the time duration.

14. The computing device as recited in claim 9, wherein the topics tracking application is configured to compute a smoothed time-series topic trending representation of the at least one topic that is trending over the time duration, the computing including the topics tracking application configured to:
model the communications that are from or between the users as a document;
assign similarity values to pairs of adjacent blocks of text in the document; and
determine a frequency of a keyword phrase localized in one or more of the blocks of text based on the similarity values to identify the at least one topic that is trending over the time duration.

15. The computing device as recited in claim 9, wherein the topics tracking application is configured to said generate the visual dashboard to display any one or combination of:
one or more data sources of the communications that are from or between the two or more users;
an overview of one or more of the topics determined from a selected data source; and
the trending representation of the at least one topic that is trending over the time duration.

16. The computing device as recited in claim 15, wherein the topics tracking application is configured to receive a user input of a section of the trending representation, and wherein the visual dashboard displays a section of the data source that corresponds to the section of the trending representation.

17. A computer-readable storage memory comprising a topics tracking application stored as instructions that are executable and, responsive to execution of the instructions by a computing device, the computing device performs operations of the topics tracking application comprising to:
receive input text data as communications from a user or between users, the communications being from the user to one or more of the users, or between two or more of the users;
determine one or more topics from the communications that are from or between the users;
track how the one or more topics are trending over a time duration; and
generate a visual dashboard that displays a trending representation of at least one of the topics that is trending over the time duration.

18. The computer-readable storage memory as recited in claim 17, wherein:
the time duration is a sliding time window for the trending representation of the at least one topic, and the trending representation indicates that the topic is trending up or down over the time duration;
the computing device performs the operations of the topics tracking application further comprising to:
model the communications that are from or between the users as a document; and
scan keywords of the document to form the sliding time window for the trending representation of the at least one topic.

19. The computer-readable storage memory as recited in claim 17, wherein the visual dashboard displays any one or combination of:
one or more data sources of the communications that are from or between the users;
an overview of one or more of the topics determined from a selected data source; and
the trending representation of the at least one topic that is trending over the time duration.

20. The computer-readable storage memory as recited in claim 19, wherein the computing device is configured to receive a user input of a section of the trending representation, and wherein the visual dashboard displays a section of the data source that corresponds to the section of the trending representation.
